(19) United States
(12) Patent Application Publication
(10) Pub. No.: US 2025/0225703 A1
(43) Pub. Date: Jul. 10, 2025

(54) IMAGE PROCESSING METHOD AND APPARATUS, ELECTRONIC DEVICE, AND STORAGE MEDIUM

(71) Applicant: Beijing Zitiao Network Technology Co., Ltd., Beijing (CN)

(72) Inventors: Yongsheng DONG, Beijing (CN); Donghao WANG, Beijing (CN); Guohong WU, Beijing (CN); Qian HE, Beijing (CN)

(21) Appl. No.: 19/017,185

(22) Filed: Jan. 10, 2025

(30) Foreign Application Priority Data
Jan. 10, 2024 (CN) 202410039696.2

(51) Int. Cl. G06T 11/60; G06T 17/20; G06V 10/44

(52) U.S. Cl. CPC G06T 11/60; G06T 17/20; G06V 10/44

(57) ABSTRACT

Embodiments of the present disclosure provide an image processing method and apparatus, an electronic device, and a storage medium. The method includes: obtaining an image to be processed that includes a target object; processing the image to be processed based on a pre-trained stylization model to obtain a target style image with the target object stylized as well as key point information of the target object after stylization; and processing, based on a preset target task and the key point information, the target style image to obtain a target special effect corresponding to the target task.

### CROSS-REFERENCE TO RELATED APPLICATION(S)

This application claims priority to Chinese Application No. 202410039696.2 filed on Jan. 10, 2024, the disclosure of which is incorporated herein by reference in its entity.

### FIELD

Embodiments of the present disclosure relate to the technical field of image processing, and in particular, to an image processing method and apparatus, an electronic device, and a storage medium.

### BACKGROUND

At present, when special effect tasks are performed on images, the images are generally stylized, or the images are subjected to special effect processing by using special effect props so as to obtain special effect images. Then, the special effect images are processed based on the special effect tasks to obtain special effect data.

However, when the images are processed in the above manner, target objects in the obtained special effect images are usually deformed. Therefore, when the special effect images are processed based on the special effect tasks, there may be problems such as a poor display effect of the special effect data, i.e., a poor degree of matching between the special effects and the target objects, due to the inability to accurately apply a special effect task to the target object.

### SUMMARY

The present disclosure provides an image processing method and apparatus, an electronic device, and a storage medium, so as to achieve the effect of accurately determining key point information of a target object after stylization, thereby realizing the effect of deeply coupling image stylization with key point detection for an object and improving the degree of matching between a target task and the key point information of the target object.

According to a first aspect, an embodiment of the present disclosure provides an image processing method.

The method includes:
obtaining an image to be processed that includes a target object;
processing the image to be processed based on a pre-trained stylization model to obtain a target style image with the target object stylized as well as key point information of the target object after the stylization; and
processing, based on a preset target task and the key point information, the target style image to obtain a target special effect corresponding to the target task.

According to a second aspect, an embodiment of the present disclosure further provides an image processing apparatus. The apparatus includes:
an image obtaining module configured to obtain an image to be processed that includes a target object;
an image processing module configured to process the image to be processed based on a pre-trained stylization model to obtain a target style image with the target object stylized as well as key point information of the target object after stylization; and
a special effect determining module configured to process, based on a preset target task and the key point information, the target style image to obtain a target special effect corresponding to the target task.

According to a third aspect, an embodiment of the present disclosure further provides an electronic device. The electronic device includes:
one or more processors; and
a storage apparatus configured to store one or more programs, where
the one or more programs, when executed by the one or more processors, cause the one or more processors to implement the image processing method according to any one of the embodiments of the present disclosure.

According to a fourth aspect, an embodiment of the present disclosure further provides a storage medium comprising computer-executable instructions, where the computer-executable instructions, when executed by a computer processor, are used to perform the image processing method according to any one of the embodiments of the present disclosure.

### BRIEF DESCRIPTION OF THE DRAWINGS

The foregoing and other features, advantages, and aspects of embodiments of the present disclosure become more apparent with reference to the following specific implementations and in conjunction with the accompanying drawings. Throughout the drawings, the same or similar reference numerals denote the same or similar elements. It should be understood that the accompanying drawings are schematic and that parts and elements are not necessarily drawn to scale.

FIG. 1 is a schematic flowchart of an image processing method according to an embodiment of the present disclosure;

FIG. 2 is a schematic flowchart of another image processing method according to an embodiment of the present disclosure;

FIG. 3 is a schematic diagram of a stylization model according to an embodiment of the present disclosure;

FIG. 4 is a schematic flowchart of another image processing method according to an embodiment of the present disclosure;

FIG. 5 is a schematic diagram of a structure of an image processing apparatus according to an embodiment of the present disclosure; and

FIG. 6 is a schematic diagram of a structure of an electronic device according to an embodiment of the present disclosure.

### DETAILED DESCRIPTION OF EMBODIMENTS

The embodiments of the present disclosure are described in more detail below with reference to the accompanying drawings. Although some embodiments of the present disclosure are shown in the accompanying drawings, it should be understood that the present disclosure may be implemented in various forms and should not be construed as being limited to the embodiments set forth herein. Rather, these embodiments are provided for a more thorough and complete understanding of the present disclosure. It should be understood that the accompanying drawings and the embodiments of the present disclosure are only for exemplary purposes, and are not intended to limit the scope of protection of the present disclosure.

It should be understood that the various steps described in the method implementations of the present disclosure may be performed in different orders, and/or performed in parallel. Furthermore, additional steps may be included and/or the execution of the illustrated steps may be omitted in the method implementations. The scope of the present disclosure is not limited in this respect.

The term “include/comprise” used herein and the variations thereof are an open-ended inclusion, namely, “include/comprise but not limited to”. The term “based on” is “at least partially based on”. The term “an embodiment” means “at least one embodiment”. The term “another embodiment” means “at least one another embodiment”. The term “some embodiments” means “at least some embodiments”. Related definitions of the other terms will be given in the description below.

It should be noted that concepts such as “first” and “second” mentioned in the present disclosure are only used to distinguish different apparatuses, modules, or units, and are not used to limit the sequence of functions performed by these apparatuses, modules, or units or interdependence.

It should be noted that the modifiers “one” and “a plurality of” mentioned in the present disclosure are illustrative and not restrictive, and those skilled in the art should understand that unless the context clearly indicates otherwise, the modifiers should be understood as “one or more”.

The names of messages or information exchanged between a plurality of apparatuses in the implementations of the present disclosure are used for illustrative purposes only, and are not used to limit the scope of these messages or information.

It can be understood that before the use of the technical solutions disclosed in the embodiments of the present disclosure, a user shall be informed of the type, range of use, use scenarios, etc., of personal information involved in the present disclosure in an appropriate manner in accordance with the relevant laws and regulations, and the authorization of the user shall be obtained.

For example, in response to reception of an active request from the user, prompt information is sent to the user to clearly inform the user that a requested operation will require access to and use of the personal information of the user. As such, the user can independently choose, based on the prompt information, whether to provide the personal information to software or hardware, such as an electronic device, an application, a server, or a storage medium, that performs operations in the technical solutions of the present disclosure.

As an optional but non-limiting implementation, in response to the reception of the active request from the user, the prompt information may be sent to the user in the form of, for example, a pop-up window, in which the prompt information may be presented in text. Furthermore, the pop-up window may further include a selection control for the user to choose whether to “agree” or “disagree” to provide the personal information to the electronic device.

It can be understood that the above process of notifying and obtaining the authorization of the user is only illustrative and does not constitute a limitation on the implementations of the present disclosure, and other manners that satisfy the relevant laws and regulations may also be applied in the implementations of the present disclosure.

It can be understood that the data involved in the technical solutions (including, but not limited to, the data itself and the access to or use of the data) shall comply with the requirements of corresponding laws, regulations, and relevant provisions.

Before the technical solutions are described, an exemplary description may be given to the application scenario. The technical solutions can be applied to any scenario where a special effect task needs to be performed for a stylized style image. Exemplarily, when an image to be processed that includes a target object is obtained, the image to be processed may be stylized to obtain a stylized special effect image. In this case, the target object in the image may be a stylized object. Further, a key point of the target object after stylization may be determined, so as to process the stylized special effect image based on the special effect task and key point information to obtain a target special effect. In the related art, the key point of the target object is typically determined by a key point detection algorithm. However, the key point detection algorithm is trained based on real data of the target object, and a detection result may be inaccurate when the key point detection is performed on the target object after stylization, and thus a special effect element cannot be accurately mounted on the target object.

In this case, based on the technical solution of this embodiment of the present disclosure, after the image to be processed that includes the target object is obtained, the image to be processed may be input into a stylization model, so as to perform stylization and key point determination on the image to be processed based on the stylization model. Then, a target style image with the target object stylized as well as the key point information of the target object after the stylization may be obtained. Further, the target style image is processed based on a preset target task and the key point information to obtain a target special effect corresponding to the target task. Therefore, this achieves the effects of both stylizing an image and performing key point determination on the stylized image, which achieves the effect of accurately determining the position of the key point of the stylized object and achieves the effect of performing the target task on the target object based on the key point information to obtain the target special effect, thereby improving the degree of matching between the target task and the key point information of the target object.

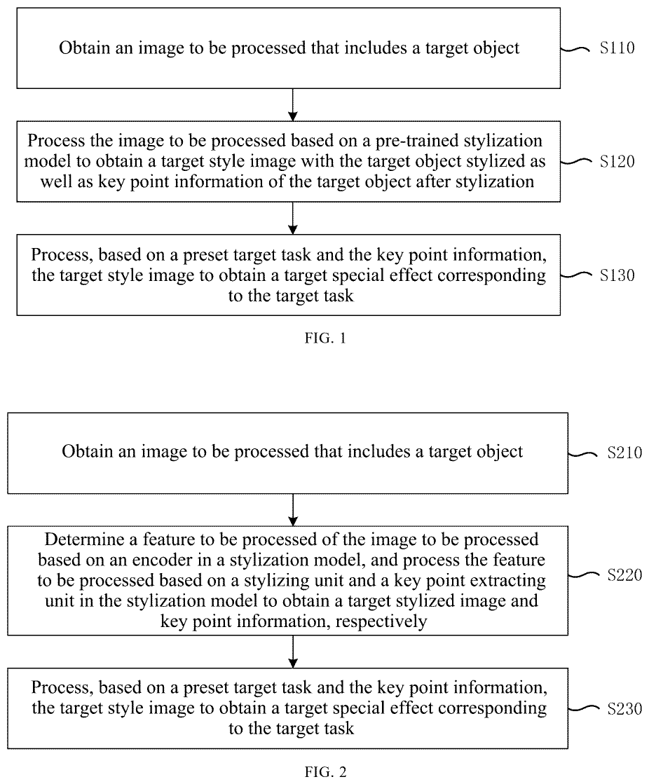

FIG. 1 is a schematic flowchart of an image processing method according to an embodiment of the present disclosure. This embodiment of the present disclosure is applicable to a case where key point determination is performed on a stylized object and a special effect task is performed on an object in a special effect image based on key point information. The method can be performed by an image processing apparatus. The apparatus may be implemented in the form of software and/or hardware. Optionally, the apparatus may be implemented by an electronic device, and the electronic device may be a mobile terminal, a PC, a server, or the like.

As shown in FIG. 1, the method in this embodiment may specifically include the following steps.

S110: Obtain an image to be processed that includes a target object.

In this embodiment, the image to be processed may be understood as an image requiring special effect processing. Optionally, the image to be processed may be a default template image, an image acquired based on a terminal device, an image obtained from a target storage space (such as an image library of application software, or a gallery of a local terminal) in response to a trigger operation from a user, or an image received from an upload by an external device. The terminal device may refer to an electronic device with an image shooting function, such as a camera, a smart phone, and a tablet computer. Accordingly, the image to be processed may include the target object. The target object may be understood as an object to be subjected to special effect processing. The target object may be any type of object included in the image. Optionally, the target object includes a human object, an animal object, or a limb part associated with the user.

It should be noted that the number of target objects included in the image to be processed may be one or more. Regardless of whether it is one or more, the target object can be processed by using the technical solution provided in this embodiment of the present disclosure.

In practical application, when special effect processing is performed on any image and/or an object in the image, the image to be processed that includes the target object may be obtained first. Then, the subsequent image processing flow may be continued for the obtained image to be processed.

It should be noted that the terminal device obtaining the image to be processed may be a terminal supporting special effect processing on the image, for example, a user terminal registered in application software having a special effect processing function; or a user terminal registered in application software with a special effect prop production function, which is not specifically limited in the embodiments of the present disclosure.

S120: Process the image to be processed based on a pre-trained stylization model to obtain a target style image with the target object stylized as well as key point information of the target object after the stylization.

In this embodiment, the stylization model may be a neural network model that uses an image as an input object, stylizes the image and determines key point information, and outputs an image of a particular stylized type and key point information. The stylization model may include a stylizing unit that stylizes the image and a key point extracting unit that performs key point detection and extraction on the stylized image. The stylizing unit may be a neural network model of any structure, and optionally, may be a generative adversarial network (GAN). The key point extracting unit may be any neural network model that enables key point detection and extraction of a target object in an image. Optionally, the key point extracting unit may include a down-sampling layer, a flatten layer, and a linear layer. It should be noted that the stylization model may further include an encoder, and thus feature extraction may be performed on the image to be processed based on the encoder so as to obtain rich and non-redundant image features. Further, the extracted image features may be separately used as inputs to the stylizing unit and the key point extracting unit, and a stylized image corresponding to the image to be processed and the key point information of the target object after the stylization are obtained. The benefits of providing the encoder in the stylization model are as follows. Redundant image features can be removed from the image to be processed, such that the processing efficiency of the stylization model and the accuracy of key point extraction can be improved, thereby improving the image effect of the stylized image. It should be further noted that the stylization model is in a one-to-one correspondence with the stylized special effect, i.e., the stylization model corresponding to any stylized special effect can only output a target style image corresponding to the stylized special effect.

In this embodiment, after the image to be processed that includes the target object is obtained, the image to be processed may be input into the stylization model, so as to process the image to be processed based on the stylization model to obtain the target style image with the target object stylized as well as the key point information of the target object after the stylization.

The target style image may be understood as a special effect image with a stylized special effect added to the target object in the image. It should be noted that dimensionality of the target style image may be associated with the stylizing unit in the stylization model. Exemplarily, if the stylizing unit is a deformation stylizing unit, the dimensionality of the target style image may be 6. If the stylizing unit is a non-deformation stylizing unit, the dimensionality of the target style image may be 3 or 4.

The key point information may be understood as information representing the position of key points on the target object. The key points on the target object may be predefined key points, and the number of key points may be one or more. The key point information may include any coordinate information that can represent the position of the key point in a coordinate system in which the key point is located. Optionally, the key point information includes a pixel coordinate of the predefined key point after the target object is deformed. Alternatively, the key point information includes a pixel coordinate and a depth coordinate of the predefined key point after the target object is deformed. The predefined key point may be understood as a predetermined key point corresponding to the target object. The number of key points may be one or more. The deformation of the target object may be understood as stylizing the target object to deform the target object. The pixel coordinate may be a position coordinate of the key point in the image, and information stored in the coordinate is pixel information of the key point. The depth coordinate can represent a coordinate value of depth information of the key point in the image. The depth information may be a shooting distance between the target object in the image and a shooting apparatus. When the key point information includes the pixel coordinate of the key point after the target object is deformed, the key point may be a two-dimensional key point. When the key point information includes the pixel coordinate and the depth coordinate of the key point after the target object is deformed, the key point may be a three-dimensional key point. It should be noted that the benefits of including the pixel coordinate or including the pixel coordinate and the depth coordinate in the key point information are as follows. It can enable the key point information finally obtained to be used to perform both a task for mounting a two-dimensional special effect object and a task for mounting a three-dimensional special effect object, thereby improving the flexibility of the key point information.

It should be noted that whether the key point information finally output by the stylization model includes the pixel coordinate or includes the pixel coordinate and the depth coordinate is associated with the target task to be performed based on the key point information. When the target task is a task that can be performed without depth information, the key point information may include the pixel coordinate of the key point after the target object is deformed. When the target task is a task that can only be performed with depth information, the key point information may include the pixel coordinate and the depth coordinate of the key point after the target object is deformed.

During practical application, the obtained image to be processed that includes the target object may be input into the stylization model. Then, feature extraction may be performed on the image to be processed based on the encoder in the stylization model to obtain a feature to be processed. The feature to be processed may then be processed based on the stylizing unit to stylize the target object and obtain the target style image. Meanwhile, the feature to be processed may be processed based on the key point extracting unit to detect the predefined key point after the target object is deformed and to extract the key point information. Then, the key point information of the target object after the stylization may be obtained.

S130: Process, based on a preset target task and the key point information, the target style image to obtain a target special effect corresponding to the target task.

It should be noted that for the target style image, after the target style image is obtained, the target style image may be directly displayed in a display interface; and for the key point information, the key point information may be associated with the subsequent target task to be performed and may provide an execution basis for the subsequent target task to be performed. Therefore, after the key point information is obtained, the predefined key point may be displayed without relying on the key point information before the target task is received. When the target task is received, the target task may then be performed on the target style image based on the key point information.

In this embodiment, the target task may be understood as a special effect task performed based on the key point information. The target task may be a task for mounting a special effect object at the key point of the target object. Optionally, the target task may include a task for mounting a two-dimensional special effect object and/or a three-dimensional special effect object for the target object based on the key point information. For example, the target task may be to mount an earring special effect at the key point of the target object. The two-dimensional special effect object may be understood as a two-dimensional special effect element that can be mounted on the target object. The three-dimensional special effect object may be understood as a three-dimensional special effect element that can be mounted on the target object. The target special effect may be understood as a special effect image that corresponds to the target style image and where the special effect object is mounted on the target object.

It should be noted that the target task may include the two-dimensional special effect object and the three-dimensional special effect object at the same time, or either the two-dimensional special effect object or the three-dimensional special effect object. Moreover, there may be one or more types of special effect objects (including the two-dimensional special effect object and/or the three-dimensional special effect object) included in the target task, which is not specifically limited in the embodiments of the present disclosure.

In practical application, if there exists a preset target task, the special effect object to be mounted (including the two-dimensional special effect object and/or the three-dimensional special effect object) may be determined based on the target task. Further, the determined special effect object may be mounted to the target object based on the key point information so as to process the target style image. Then, the target special effect corresponding to the target task may be obtained. The benefit of such a setting is as follows. It achieves the effect of mounting the special effect object for the target object based on the key point information to obtain the target special effect, thereby improving the adaptability between the special effect object to be mounted and the target object.

Exemplarily, assuming that the target task is to mount the special effect earring for the target object based on the key point information, the determined key point information may include ear key point information of the target object. After the target stylized image and the key point information are obtained, the special effect earring may be mounted to the ears of the target object based on the ear key point information, and then the target stylized image where the target object is mounted with the earring special effect may be obtained, which image can be used as the target special effect corresponding to the target task.

In the technical solutions of the embodiments of the present disclosure, the image to be processed that includes the target object is obtained, further, the image to be processed is processed based on the pre-trained stylization model to obtain the target style image with the target object stylized as well as the key point information of the target object after the stylization, and finally, the target style image is processed based on the preset target task and the key point information to obtain the target special effect corresponding to the target task. This solves the problems in the related art, such as a poor display effect of special effect data due to the inability to accurately apply a special effect task to the target object when the image is processed; achieves the effect of accurately determining the key point information of the target object after the stylization, thereby realizing the effect of deeply coupling image stylization with key point detection for the object and further improving the accuracy and effect of key point detection; and achieves the effect of performing the target task on the target object based on the key point information to obtain the target special effect, thereby improving the degree of matching between the target task and the key point information of the target object.

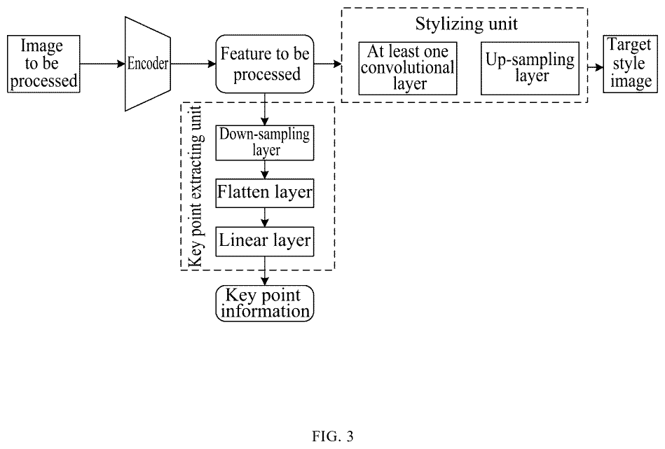

FIG. 2 is a schematic flowchart of another image processing method according to an embodiment of the present disclosure. On the basis of the above embodiment, in the technical solution of this embodiment, the image to be processed may be input into the stylization model, and the image to be processed may be processed based on the encoder, the stylizing unit, and the key point extracting unit in the stylization model. Then, the target stylized image and the key point information may be obtained. For a specific implementation, reference may be made to the description of this embodiment. Details about technical features that are the same as or similar to those in the foregoing embodiment are not repeated herein.

As shown in FIG. 2, the method in this embodiment may specifically include the following steps.

S210: Obtain an image to be processed that includes a target object.

S220: Determine a feature to be processed of the image to be processed based on an encoder in a stylization model, and process the feature to be processed based on a stylizing unit and a key point extracting unit in the stylization model to obtain a target stylized image and key point information, respectively.

The encoder may be understood as a neural network model that processes an image into features of corresponding feature dimensions. In this embodiment, the encoder in the stylization model may be a neural network model consisting of at least one convolutional layer and a down-sampling layer, and the neural network model can encode the image to be processed into a feature image of a particular dimension. The stylizing unit may be understood as a neural network model that enables stylization of the target object. The stylizing unit may be a neural network model based on a generative adversarial network (GAN). The stylizing unit may be a neural network model consisting of at least one convolutional layer and an up-sampling layer. The key point extracting unit may be understood as a neural network model that enables key point detection and key point information extraction. The key point extracting unit may be a neural network model consisting of a down-sampling layer, a flatten layer, and a linear layer.

In practical application, after the image to be processed is input into the stylization model, feature extraction may be performed on the image to be processed based on the encoder in the stylization model to obtain the feature to be processed of the image to be processed. The feature to be processed output by the encoder may be a local image feature in the image to be processed. Compared with global image features, local image features have the characteristics of a rich quantity contained in the image, a low correlation between the features, avoidance of affecting the detection and matching of other features by disappearance of part of the features in the case of occlusion, and so on, and therefore features to be processed may also be understood as local representations of the image feature that reflect local features present on the image to be processed, and such features can be applied in application scenarios of matching and processing images, and so on. The benefit of such a setting is as follows. It can improve the efficiency of the subsequent feature extraction so as to speed up model calculations.

Further, the feature to be processed may be processed based on the stylizing unit in the stylization model. Then, a target style image with the target object stylized may be obtained. In addition, the feature to be processed may be processed based on the key point extracting unit in the stylization model. Then, the key point information of the target object after the stylization may be obtained. The process of processing the feature to be processed by the stylizing unit and process of processing the feature to be processed by the key point extracting unit may be described in detail below.

Optionally, the processing the feature to be processed based on a stylizing unit and a key point extracting unit in the stylization model to obtain a target stylized image and key point information, respectively includes: processing the feature to be processed based on at least one convolutional layer and an up-sampling layer in the stylizing unit to obtain the target style image with the target object deformed; and processing the feature to be processed sequentially based on a down-sampling layer, a flatten layer, and a linear layer in the key point extracting unit to obtain the key point information after the target object is deformed.

The flatten layer may be understood as a neural network model for performing flatten operations on features. The flatten layer is used for converting multi-dimensional input data into a one-dimensional array, and is usually used between a convolutional neural network and a fully connected layer, without changing the total amount of data, but only the shape of the data. Exemplarily, assuming that there is a three-dimensional feature map, after being processed based on the flatten layer, the feature map is converted into a one-dimensional array to function as the input to the fully connected layer. The linear layer is also known as a fully connected layer, where each node in the fully connected layer is connected to all nodes of a previous layer and is used for combining previously extracted local features, and its output is a feature value.

In practical application, after the feature to be processed is obtained, the feature to be processed may be processed based on the at least one convolutional layer and the up-sampling layer in the stylizing unit, so that after the feature to be processed is processed based on the at least one convolutional layer, the processed feature to be processed can be restored to an image of its original size based on the up-sampling layer, and the image can be used as the target style image with the target object deformed. In addition, after the feature to be processed is obtained, the feature to be processed may be processed based on the down-sampling layer in the key point extracting unit to reduce the feature size of the feature to be processed and decrease the feature dimension of the feature to be processed. Then, the processed feature to be processed may be flattened based on the flatten layer, and finally, the flattened feature may be mapped based on the linear layer so that the key point information after the target object is deformed can be obtained. The benefit of such a setting is as follows. It achieves the effect of performing stylization and key point determination on the image to be processed at the same time based on the stylization model, which improves the accuracy of key point detection.

Exemplarily, the process of processing the image to be processed based on the stylization model may be described with reference to FIG. 3. Assuming that the image size of the image to be processed is 512×512×3, after the image to be processed is input into the stylization model, feature extraction may be performed on the image to be processed based on the encoder to obtain a feature to be processed. In this case, the feature size of the obtained feature to be processed is 4×4. Further, the feature to be processed may be processed based on the at least one convolutional layer and the up-sampling layer in the stylizing unit so as to encode and restore the feature to be processed into an image of an image size of 512×512×6, which may be used as the target style image. In addition, the feature to be processed may be processed based on the down-sampling layer in the key point extracting unit to reduce the dimensions of the feature to be processed of the size of 4×4 to a feature of the size of 1×1. Then, the feature may be flattened based on the flatten layer, and finally, the flattened feature may be mapped into a finally required key point coordinate by a linear layer, and the key point coordinate may be used as the key point information after the target object is deformed.

S230: Process, based on a preset target task and the key point information, the target style image to obtain a target special effect corresponding to the target task.

In the technical solution of this embodiment of the present disclosure, the image to be processed that includes the target object is obtained, further, the feature to be processed of the image to be processed is determined based on the encoder in the stylization model, and the feature to be processed is processed based on the stylizing unit and the key point extracting unit in the stylization model to obtain the target stylized image and the key point information, respectively, and finally the target style image is processed based on the preset target task and the key point information to obtain the target special effect corresponding to the target task. This achieves the effect of performing stylization and key point determination on the image based on the stylization model, thereby achieving an effect of deeply coupling image stylization with key point detection for the object, and thus improving the accuracy and efficiency of key point detection.

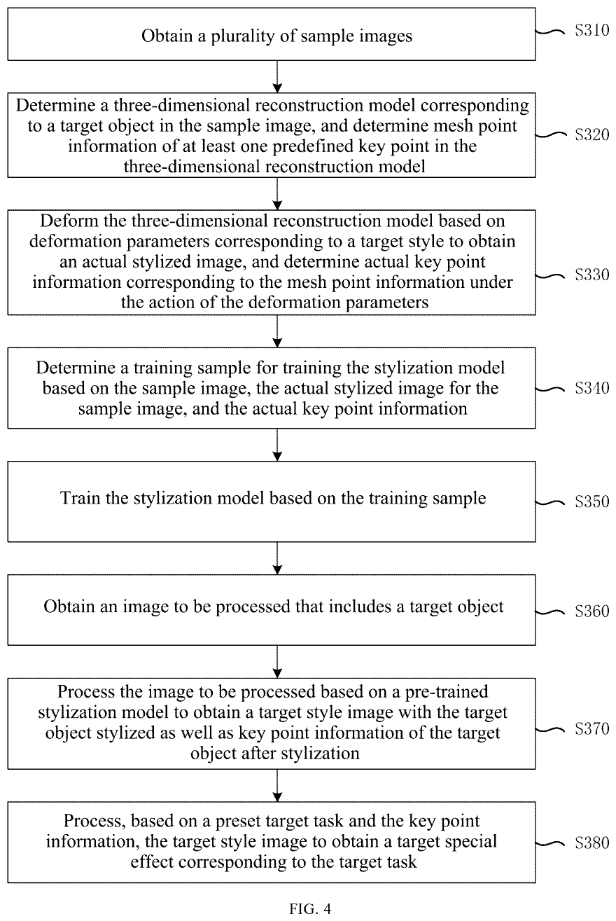

FIG. 4 is a schematic flowchart of another image processing method according to an embodiment of the present disclosure. On the basis of the above embodiments, the technical solution of this embodiment, before processing the image to be processed based on the stylization model, may obtain sample images, and determine a three-dimensional reconstruction model corresponding to a target object in the sample image, and determine mesh point information of each key point in the three-dimensional reconstruction model, and further deform the three-dimensional reconstruction model based on deformation parameters to obtain an actual stylized image, and determine actual key point information corresponding to the mesh point information under the action of the deformation parameters, so as to construct a training sample. Then, the stylization model may be trained based on the training sample. For a specific implementation, reference may be made to the description of this embodiment. Details about technical features that are the same as or similar to those in the foregoing embodiment are not repeated herein.

As shown in FIG. 4, the method in this embodiment may specifically include the following steps.

S310: Obtain a plurality of sample images.

The sample images may be images shot by a camera apparatus, or images reconstructed by an image reconstruction model, or images pre-stored in a storage space. Meanwhile, the sample image may include one or more objects, and an object included in the image may be used as a target object.

In practical application, before the stylization model is trained, a plurality of training samples may be obtained to train the model based on the training samples. In order to improve the accuracy of the model, as many and rich training samples as possible may be constructed. In order to construct the training samples, a plurality of sample images may be obtained. Then, the sample images may be processed to obtain the training samples for training the stylization model.

S320: Determine a three-dimensional reconstruction model corresponding to a target object in the sample image, and determine mesh point information of at least one predefined key point in the three-dimensional reconstruction model.

It should be noted that for each of the sample images, the corresponding three-dimensional reconstruction model and the mesh point information of the key point in the three-dimensional reconstruction model may be determined in the manner of S320.

The three-dimensional reconstruction model may be understood as a three-dimensional model constructed based on the target object, and the model structure of this model corresponds to the object size and the object proportion of the target object. In practical application, when the target object is detected in the sample image by the application, a three-dimensional reconstruction model corresponding to the target object that is generated in advance or in real time may be retrieved. For example, when the target object is detected in the sample image by the application, a 3D mesh reflecting limb features of the target object may be constructed in real time using a plurality of patches. Then, the 3D mesh is used as the three-dimensional reconstruction model corresponding to the target object. Further, after the completion of the reconstruction of the three-dimensional reconstruction model, the application may further label the model and associate the model with an object identifier of the target object. Based on this, if the target object is detected in the sample image again in the subsequent process by the application, the constructed 3D mesh may be invoked directly as the three-dimensional reconstruction model. In this embodiment, the three-dimensional reconstruction model may be composed of at least one patch, and each patch may be further composed of three vertices, where the patch may be used as a mesh model and the vertices as model vertices. Therefore, the mesh point information of the key point in the three-dimensional reconstruction model may be understood as model vertex information corresponding to the key point, i.e., information characterizing the position of the key point on the three-dimensional reconstruction model. The mesh point information may be spatial position information. In practical application, after the plurality of sample images are obtained, for each of the sample images, upon detection of inclusion of the target object in the sample image, the three-dimensional reconstruction model corresponding to the target object may be determined. Further, based on position information of each predefined key point on the target object, the mesh point information of the each key point in the three-dimensional reconstruction model may be determined.

S330: Deform the three-dimensional reconstruction model based on deformation parameters corresponding to a target style to obtain an actual stylized image, and determine actual key point information corresponding to the mesh point information under the action of the deformation parameters.

In this embodiment, the target style may be understood as a special effect that can perform stylized special effect processing on the target object. The target style may be in a one-to-one correspondence with the stylization model to be trained, i.e., one target style may correspond to one stylization model, and the stylization model may output a target style image corresponding to the target style. Optionally, the target style may include a deformation style and/or a non-deformation style. The deformation style may be understood as a special effect that performs deformation stylization on the target object to change the object shape of the target object. The non-deformation style may be understood as a stylized special effect that does not change the object shape of the target object. Optionally, the non-deformation style may include a material style, i.e., a special effect that can change surface attributes of the target object, or a special effect that can change a skin texture feature and/or a skin display color of the target object in the image to be processed. The deformation parameters may be parameters for indicating a stylized deformation effect that the target object finally presents. The deformation parameters correspond to the target style, and are parameters that characterize the degree of deformation corresponding to the target style. The actual stylized image may be understood as a style image obtained after stylizing the target object in the sample image based on the target style. The actual key point information may be understood as key point information of the target object after stylization.

It should be noted that the deformation parameters may be parameters determined during the construction of the target style, and these parameters may be parameters obtained after a number of edits so that the finally determined deformation parameters can present the stylized special effect corresponding to the target style to the greatest extent.

In practical application, the deformation parameters corresponding to the target style may be obtained after the three-dimensional reconstruction model corresponding to the target object is determined. Further, the three-dimensional reconstruction model may be deformed based on the deformation parameters for the target style, so as to obtain the deformed three-dimensional reconstruction model. Then, the deformed three-dimensional reconstruction model may be rendered, resulting in the actual stylized image corresponding to the sample image, where the stylized image matches the target style.

Further, the actual key point information corresponding to the mesh point information under the action of the deformation parameters may be determined, and the actual key point information may be determined by projecting the mesh point information under the action of the deformation parameters to a screen coordinate system.

Optionally, the determining actual key point information corresponding to the mesh point information under the action of the deformation parameters includes: determining coordinate data corresponding to the mesh point information under the action of the deformation parameters; and based on the coordinate data, a model matrix, a view matrix, and a projection matrix, determining an actual pixel coordinate of the mesh point information in the sample image and using the actual pixel coordinate as the actual key point information.

In this embodiment, the coordinate data may be understood as coordinate data of the key point on the three-dimensional reconstruction model under the action of the deformation parameters. The model matrix may be a matrix that characterizes position information of the target object in a world coordinate system. The view matrix may be a matrix that characterizes position information of a camera in the world coordinate system. The projection matrix may be a projection transform matrix of the camera. The actual pixel coordinate may be understood as the coordinate data of the mesh point information in the sample image, and coordinate information stored in the coordinate data is pixel information.

In practical application, after the three-dimensional reconstruction model is deformed based on the deformation parameters, the coordinate data corresponding to the mesh point information under the action of the deformation parameters may be determined based on the deformation parameters and the mesh point information. Further, the model matrix, the view matrix, and the projection matrix may be determined, and the coordinate data may be subjected to matrix transform based on the model matrix, the view matrix, and the projection matrix. Then, the actual pixel coordinate of the mesh point information in the sample image may be obtained, and the actual pixel coordinate may be used as the actual key point information. The benefit of such a setting is as follows. It achieves the effect of accurately labeling the position of the key point in the training data, thereby realizing the effect of improving the efficiency of preparation of key point training data the basis of reducing the preparation cost of the training data.

S340: Determine a training sample for training the stylization model based on the sample image, the actual stylized image for the sample image, and the actual key point information.

In practical application, after the sample image, the actual stylized image corresponding to the sample image, and the actual key point information are obtained, the training sample may be constructed based on the sample image, the actual stylized image corresponding thereto, and the actual key point information. In this way, each training sample includes a sample image, an actual stylized image corresponding to the sample image, and actual key point information.

It should be noted that if the target task performed based on the key point information includes a task for mounting a three-dimensional special effect object for the target object based on the key point information, in order to improve the adaptability between the mounted three-dimensional special effect object and the target object, it is also possible to use a depth coordinate of the mesh point information as the actual key point information, so that the actual key point information corresponding to the mesh point information under the action of the deformation parameters includes the actual pixel coordinate and the depth coordinate of the key point information.

Based on this, on the basis of the above technical solutions, the method further includes: when the target task includes mounting a three-dimensional special effect object for the target object, determining a depth coordinate of the mesh point information and updating the training sample based on the depth coordinate.

In this embodiment, the depth coordinate may characterize a distance between a mesh point and the camera, i.e., depth information of the mesh point.

In practical application, when the target task includes mounting the three-dimensional special effect object for the target object, the distance between the mesh point information and the camera may be determined, and then the depth coordinate of the mesh point information may be obtained. Further, the training sample may be updated based on the depth coordinate, so that the training sample may include the depth coordinate of the mesh point information.

It should be noted that after the actual key point information in the training sample is obtained, the actual key point information may be normalized, so that the actual pixel coordinate and the depth coordinate in the actual key point information are both normalized to an interval from −1 to 1.

S350: Train the stylization model based on the training sample.

In this embodiment, after the plurality of training samples are obtained, the stylization model may be trained based on the training samples. It should be noted that for each training sample, the training thereof may be performed by using the following procedure so as to obtain the stylization model.

Optionally, the training the stylization model based on the training sample includes: inputting the sample image in the training sample into the stylization model to perform stylization and key point determination, and output a predicted stylized image and predicted key point information; and determining a loss value based on the actual stylized image, the actual key point information, the predicted stylized image, and the predicted key point information of the training sample, and correcting model parameters in the stylization model based on the loss value until a loss function in the stylization model converges.

In this embodiment, the predicted stylized image may be a stylized image output after stylizing the target object after the sample image is input into the stylization model. The predicted key point information may be key point information of the target object after stylization output after the sample image is input into the stylization model. The loss value may be a numerical value that characterizes a degree of difference between a predicted output and an actual output. The loss function may be a function that is determined based on the loss value and is used for characterizing the degree of difference between the predicted output and the actual output.

In practical application, for each training sample, the sample image in the training sample may be input into the stylization model, and feature extraction may be performed on the sample image based on the encoder in the stylization model to obtain a sample feature to be processed of the sample image. Then, stylization and key point determination may be performed on the sample feature to be processed based on the stylizing unit and the key point extracting unit in the stylization model, respectively. Thereby, the predicted stylized image and the predicted key point information can be output.

Further, the predicted stylized image may be compared to the actual stylized image in the training sample and the predicted key point information compared to the actual key point information in the training sample to determine the loss value. Then, the model parameters in the stylization model may be corrected based on the loss value. Afterwards, a training error of the loss function in the stylization model, i.e., a loss parameter, may be used as a condition for detecting whether the current loss function has converged, for example, whether the training error is less than a preset error, or whether an error change tends to stabilize, or whether a current number of model iterations is equal to a preset number, or the like. If it is detected that the convergence condition is satisfied, for example, that the training error of the loss function is less than the preset error or the error change tends to stabilize, it indicates that the training of the stylization model is completed, and at this time, the iterative training may be stopped. If it is detected that the convergence condition is not yet satisfied, other training samples may be further obtained to train the stylization model, until the training error of the loss function falls into a preset range. When the training error of the loss function has converged, a trained stylization model can be obtained.

S360: Obtain an image to be processed that includes a target object.

S370: Process the image to be processed based on a pre-trained stylization model to obtain a target style image with the target object stylized as well as key point information of the target object after the stylization.

S380: Process, based on a preset target task and the key point information, the target style image to obtain a target special effect corresponding to the target task.

In the technical solution of this embodiment of the present disclosure, the plurality of sample images are obtained, then the three-dimensional reconstruction model corresponding to the target object in the sample image is determined, and mesh point information of the at least one predefined key point in the three-dimensional reconstruction model is determined; and then the three-dimensional reconstruction model is deformed based on the deformation parameters corresponding to the target style to obtain the actual stylized image, and the actual key point information corresponding to the mesh point information under the action of the deformation parameters are determined; and then the training sample for training the stylization model is determined based on the sample image, the actual stylized image for the sample image, and the actual key point information; and further, the stylization model is trained based on the training sample, and then the image to be processed that includes the target object is obtained, the image to be processed is processed based on the pre-trained stylization model to obtain the target style image with the target object stylized as well as the key point information of the target object after stylization; and the target style image is processed based on the preset target task and the key point information to obtain the target special effect corresponding to the target task. It achieves an effect of training a stylization model including a stylizing unit and a key point extracting unit based on the constructed training data is achieved, and then achieves the effect of performing stylization and key point determination on the image based on the stylization model, thereby achieving an effect of deeply coupling image stylization with key point detection for the object, and thus improving the accuracy and efficiency of key point detection.

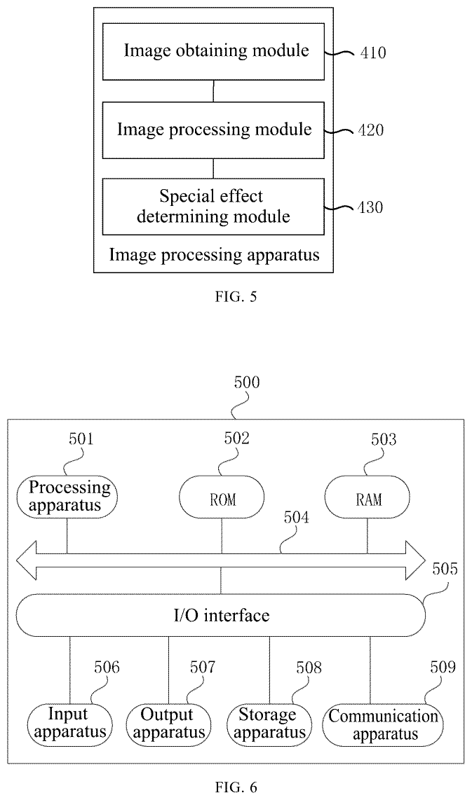

FIG. 5 is a schematic diagram of a structure of an image processing apparatus according to an embodiment of the present disclosure. As shown in FIG. 5, the apparatus includes: an image obtaining module 410, an image processing module 420, and a special effect determining module 430.

The image obtaining module 410 is configured to obtain an image to be processed that includes a target object. The image processing module 420 is configured to process the image to be processed based on a pre-trained stylization model to obtain a target style image with the target object stylized as well as key point information of the target object after stylization. The special effect determining module 430 is configured to process, based on a preset target task and the key point information, the target style image to obtain a target special effect corresponding to the target task.

On the basis of the above optional technical solutions, optionally, the image processing module 420 is specifically configured to determine a feature to be processed of the image to be processed based on an encoder in the stylization model, and process the feature to be processed based on a stylizing unit and a key point extracting unit in the stylization model to obtain the target stylized image and the key point information, respectively. On the basis of the above optional technical solutions, optionally, the image processing module 420 includes: a target style image determining unit and a key point information determining unit.

The target style image determining unit is configured to process the feature to be processed based on at least one convolutional layer and an up-sampling layer in the stylizing unit to obtain the target style image with the target object deformed; and the key point information determining unit is configured to process the feature to be processed sequentially based on a down-sampling layer, a flatten layer, and a linear layer in the key point extracting unit to obtain the key point information after the target object is deformed.

On the basis of the above optional technical solutions, optionally, the key point information includes a pixel coordinate of a predefined key point after the target object is deformed; or the key point information includes a pixel coordinate and a depth coordinate of a predefined key point after the target object is deformed.

On the basis of the above optional technical solutions, optionally, the target task includes a task for mounting a two-dimensional special effect object and/or a three-dimensional special effect object for the target object based on the key point information.

On the basis of the above optional technical solutions, optionally, the apparatus further includes: a sample image obtaining module, a model determining module, a model processing module, and a training sample determining module.

The sample image obtaining module is configured to obtain a plurality of sample images.

The model determining module is configured to determine a three-dimensional reconstruction model corresponding to a target object in the sample image, and determine mesh point information of at least one predefined key point in the three-dimensional reconstruction model.

The model processing module is configured to deform the three-dimensional reconstruction model based on deformation parameters corresponding to a target style to obtain an actual stylized image, and determine actual key point information corresponding to the mesh point information under the action of the deformation parameters.

The training sample determining module is configured to determine a training sample for training the stylization model based on the sample image, the actual stylized image for the sample image, and the actual key point information.

On the basis of the above optional technical solutions, optionally, the model processing module includes: a coordinate data determining unit and a pixel coordinate determining unit.

The coordinate data determining unit is configured to determine coordinate data corresponding to the mesh point information under the action of the deformation parameters.

The pixel coordinate determining unit is configured to, based on the coordinate data, a model matrix, a view matrix, and a projection matrix, determine an actual pixel coordinate of the mesh point information in the sample image and use the actual pixel coordinate as the actual key point information.

On the basis of the above optional technical solutions, optionally, the apparatus further includes: a depth coordinate determining module.

The depth coordinate determining module is configured to, in response to the target task including mounting a three-dimensional special effect object for the target object, determine a depth coordinate of the mesh point information and update the training sample based on the depth coordinate.

On the basis of the above optional technical solutions, optionally, the apparatus further includes: a model training module.

The model training module is configured to train the stylization model based on the training sample.

The model training module includes: a sample image processing unit and a model parameter correcting unit.

The sample image processing unit is configured to input the sample image in the training sample into the stylization model to perform stylization and key point determination, and output a predicted stylized image and predicted key point information; and the model parameter correcting unit is configured to determine a loss value based on the actual stylized image, the actual key point information, the predicted stylized image, and the predicted key point information of the training sample, and correct model parameters in the stylization model based on the loss value until a loss function in the stylization model converges.

In the technical solutions of the embodiments of the present disclosure, the image to be processed that includes the target object is obtained, further, the image to be processed is processed based on the pre-trained stylization model to obtain the target style image with the target object stylized as well as the key point information of the target object after the stylization, and finally, the target style image is processed based on the preset target task and the key point information to obtain the target special effect corresponding to the target task. This solves the problems in the related art, such as a poor display effect of special effect data due to the inability to accurately apply a special effect task to the target object when the image is processed; achieves the effect of accurately determining the key point information of the target object after the stylization, thereby realizing the effect of deeply coupling image stylization with key point detection for the object and further improving the accuracy and effect of key point detection; and achieves the effect of performing the target task on the target object based on the key point information to obtain the target special effect, thereby improving the degree of matching between the target task and the key point information of the target object.

The image processing apparatus provided in this embodiment of the present disclosure can perform the image processing method provided in any embodiment of the present disclosure, and has corresponding functional modules and beneficial effects for performing the method.

It is worth noting that the units and modules included in the above apparatus are obtained through division merely according to functional logic, but are not limited to the above division, as long as corresponding functions can be implemented. In addition, specific names of the functional units are merely used for mutual distinguishing, and are not used to limit the protection scope of the embodiments of the present disclosure.

FIG. 6 is a schematic diagram of a structure of an electronic device according to an embodiment of the present disclosure. Reference is made to FIG. 6 below, which is a schematic diagram of a structure of an electronic device (such as a terminal device or a server in FIG. 6) 500 suitable for implementing embodiments of the present disclosure. The terminal device in this embodiment of the present disclosure may include, but is not limited to, mobile terminals such as a mobile phone, a notebook computer, a digital broadcast receiver, a personal digital assistant (PDA), a PAD (tablet computer), a portable multimedia player (PMP), and a vehicle-mounted terminal (such as a vehicle navigation terminal), and fixed terminals such as a digital TV and a desktop computer. The electronic device shown in FIG. 6 is merely an example, and shall not impose any limitation on the function and scope of use of the embodiments of the present disclosure.

As shown in FIG. 6, the electronic device 500 may include a processing apparatus (e.g., a central processing unit or a graphics processing unit) 501 that may perform a variety of appropriate actions and processing in accordance with a program stored in a read-only memory (ROM) 502 or a program loaded from a storage apparatus 508 into a random access memory (RAM) 503. The RAM 503 further stores various programs and data required for the operation of the electronic device 500. The processing apparatus 501, the ROM 502, and the RAM 503 are connected to each other through a bus 504. An input/output (I/O) interface 505 is also connected to the bus 504.

Generally, the following apparatuses may be connected to the I/O interface 505: an input apparatus 506 including, for example, a touchscreen, a touchpad, a keyboard, a mouse, a camera, a microphone, an accelerometer, and a gyroscope; an output apparatus 507 including, for example, a liquid crystal display (LCD), a speaker, and a vibrator; the storage apparatus 508 including, for example, a tape and a hard disk; and a communication apparatus 509. The communication apparatus 509 may allow the electronic device 500 to perform wireless or wired communication with other devices to exchange data. Although FIG. 6 shows the electronic device 500 having various apparatuses, it should be understood that it is not required to implement or have all of the shown apparatuses. It may be an alternative to implement or have more or fewer apparatuses.

In particular, according to an embodiment of the present disclosure, the process described above with reference to the flowchart may be implemented as a computer software program. For example, this embodiment of the present disclosure includes a computer program product, which includes a computer program carried on a non-transitory computer-readable medium, where the computer program includes program code for performing the method shown in the flowchart. In such an embodiment, the computer program may be downloaded from a network through the communication apparatus 509 and installed, installed from the storage apparatus 508, or installed from the ROM 502. When the computer program is executed by the processing apparatus 501, the above-mentioned functions defined in the method of the embodiment of the present disclosure are performed.

The names of messages or information exchanged between a plurality of apparatuses in the implementations of the present disclosure are used for illustrative purposes only, and are not used to limit the scope of these messages or information.

The electronic device according to this embodiment of the present disclosure and the image processing methods according to the above embodiments belong to the same inventive concept. For the technical details not exhaustively described in this embodiment, reference may be made to the above embodiments, and this embodiment and the above embodiments have the same beneficial effects.

An embodiment of the present disclosure provides a computer storage medium having stored thereon a computer program that, when executed by a processor, causes the image processing method provided in the above embodiments to be implemented.

It should be noted that the above computer-readable medium described in the present disclosure may be a computer-readable signal medium, a computer-readable storage medium, or any combination thereof. The computer-readable storage medium may be, for example but not limited to, electric, magnetic, optical, electromagnetic, infrared, or semiconductor systems, apparatuses, or devices, or any combination thereof. A more specific example of the computer-readable storage medium may include, but is not limited to: an electrical connection having one or more wires, a portable computer magnetic disk, a hard disk, a random access memory (RAM), a read-only memory (ROM), an erasable programmable read-only memory (EPROM) (or a flash memory), an optical fiber, a portable compact disc read-only memory (CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may also be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (RF), etc., or any suitable combination thereof.

In some implementations, a client and a server may communicate using any currently known or future-developed network protocol such as a Hyper Text Transfer Protocol (HTTP), and may be connected to digital data communication (for example, communication network) in any form or medium. Examples of the communication network include a local area network (“LAN”), a wide area network (“WAN”), an internetwork (for example, the Internet), a peer-to-peer network (for example, an ad hoc peer-to-peer network), and any currently known or future-developed network.

The above computer-readable medium may be contained in the above electronic device. Alternatively, the computer-readable medium may exist independently, without being assembled into the electronic device.

The above computer-readable medium carries one or more programs that, when executed by the electronic device, cause the electronic device to: obtain an image to be processed that includes a target object; process the image to be processed based on a pre-trained stylization model to obtain a target style image with the target object stylized as well as key point information of the target object after stylization; and process, based on a preset target task and the key point information, the target style image to obtain a target special effect corresponding to the target task.

Computer program code for performing operations of the present disclosure can be written in one or more programming languages or a combination thereof, where the programming languages include but are not limited to object-oriented programming languages, such as Java, Smalltalk, and C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the case of the remote computer, the remote computer may be connected to the computer of the user through any kind of network, including a local area network (LAN) or a wide area network (WAN), or may be connected to an external computer (for example, connected through the Internet with the aid of an Internet service provider).

The flowchart and block diagram in the accompanying drawings illustrate the possibly implemented architecture, functions, and operations of the system, method, and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession can actually be performed substantially in parallel, or they can sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The related units described in the embodiments of the present disclosure may be implemented by software, or may be implemented by hardware. Names of the units do not constitute a limitation on the units themselves in some cases, for example, a first obtaining unit may alternatively be described as “a unit for obtaining at least two Internet Protocol addresses”.

The functions described herein above may be performed at least partially by one or more hardware logic components. For example, without limitation, exemplary types of hardware logic components that may be used include: a field programmable gate array (FPGA), an application-specific integrated circuit (ASIC), an application-specific standard product (ASSP), a system-on-chip (SOC), a complex programmable logic device (CPLD), and the like.

In the context of the present disclosure, a machine-readable medium may be a tangible medium that may contain or store a program used by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM) (or a flash memory), an optic fiber, a portable compact disc read-only memory (CD-ROM), an optical storage device, a magnetic storage device, or any suitable combination thereof.

The foregoing descriptions are merely preferred embodiments of the present disclosure and explanations of the applied technical principles. Those skilled in the art should understand that the scope of disclosure involved in the present disclosure is not limited to the technical solutions formed by specific combinations of the foregoing technical features, and shall also cover other technical solutions formed by any combination of the foregoing technical features or equivalent features thereof without departing from the foregoing concept of disclosure. For example, a technical solution formed by a replacement of the foregoing features with technical features with similar functions disclosed in the present disclosure (but not limited thereto) also falls within the scope of the present disclosure.

In addition, although the various operations are depicted in a specific order, it should not be construed as requiring these operations to be performed in the specific order shown or in a sequential order. Under certain circumstances, multitasking and parallel processing may be advantageous. Similarly, although several specific implementation details are included in the foregoing discussions, these details should not be construed as limiting the scope of the present disclosure. Some features that are described in the context of separate embodiments can also be implemented in combination in a single embodiment. In contrast, various features described in the context of a single embodiment may alternatively be implemented in a plurality of embodiments individually or in any suitable subcombination.

Although the subject matter has been described in a language specific to structural features and/or logical actions of the method, it should be understood that the subject matter defined in the appended claims is not necessarily limited to the specific features or actions described above. In contrast, the specific features and actions described above are merely exemplary forms of implementing the claims.

I/we claim:

1. An image processing method, comprising:
obtaining an image to be processed that comprises a target object;
processing the image to be processed based on a pre-trained stylization model to obtain a target style image with the target object stylized as well as key point information of the target object after the stylization; and
processing, based on a preset target task and the key point information, the target style image to obtain a target special effect corresponding to the target task.

2. The method according to claim 1, wherein the processing the image to be processed based on a pre-trained stylization model to obtain a target style image with the target object stylized as well as key point information of the target object after the stylization comprises:
determining a feature to be processed of the image to be processed based on an encoder in the stylization model, and processing the feature to be processed based on a stylizing unit and a key point extracting unit in the stylization model to obtain the target stylized image and the key point information, respectively.

3. The method according to claim 2, wherein the processing the feature to be processed based on a stylizing unit and a key point extracting unit in the stylization model to obtain the target stylized image and the key point information, respectively comprises:
processing the feature to be processed based on at least one convolutional layer and an up-sampling layer in the stylizing unit to obtain the target style image with the target object deformed; and
processing the feature to be processed sequentially based on a down-sampling layer, a flatten layer, and a linear layer in the key point extracting unit to obtain the key point information after the target object is deformed.

4. The method according to claim 1, wherein the key point information comprises a pixel coordinate of a predefined key point after the target object is deformed; or the key point information comprises a pixel coordinate and a depth coordinate of a predefined key point after the target object is deformed.

5. The method according to claim 1, wherein the target task comprises a task for mounting a two-dimensional special effect object and/or a three-dimensional special effect object for the target object based on the key point information.

6. The method according to claim 1, further comprising:
obtaining a plurality of sample images;
determining a three-dimensional reconstruction model corresponding to a target object in the sample image, and determining mesh point information of at least one predefined key point in the three-dimensional reconstruction model;
deforming the three-dimensional reconstruction model based on deformation parameters corresponding to a target style to obtain an actual stylized image, and determining actual key point information corresponding to the mesh point information under the action of the deformation parameters; and
determining a training sample for training the stylization model based on the sample image, the actual stylized image for the sample image, and the actual key point information.

7. The method according to claim 6, wherein the determining actual key point information corresponding to the mesh point information under the action of the deformation parameters comprises:
determining coordinate data corresponding to the mesh point information under the action of the deformation parameters; and
based on the coordinate data, a model matrix, a view matrix, and a projection matrix, determining an actual pixel coordinate of the mesh point information in the sample image and using the actual pixel coordinate as the actual key point information.

8. The method according to claim 6, wherein further comprising:
in response to the target task comprising mounting a three-dimensional special effect object for the target object, determining a depth coordinate of the mesh point information and updating the training sample based on the depth coordinate.

9. The method according to claim 6, further comprising:
training the stylization model based on the training sample,
wherein the training the stylization model based on the training sample comprises:
inputting the sample image in the training sample into the stylization model to perform stylization and key point determination, and outputting a predicted stylized image and predicted key point information; and
determining a loss value based on the actual stylized image, the actual key point information, the predicted stylized image, and the predicted key point information of the training sample, and correcting model parameters in the stylization model based on the loss value until a loss function in the stylization model converges.

10. An electronic device, comprising:
one or more processors; and
a storage apparatus configured to store one or more programs, wherein
the one or more programs, when executed by the one or more processors, cause the one or more processors to:
obtain an image to be processed that comprises a target object;
process the image to be processed based on a pre-trained stylization model to obtain a target style image with the target object stylized as well as key point information of the target object after the stylization; and
process, based on a preset target task and the key point information, the target style image to obtain a target special effect corresponding to the target task.

11. The electronic device according to claim 10, wherein the one or more processors are caused to process the image to be processed based on a pre-trained stylization model to obtain a target style image with the target object stylized as well as key point information of the target object after the stylization by being caused to:
determine a feature to be processed of the image to be processed based on an encoder in the stylization model, and process the feature to be processed based on a stylizing unit and a key point extracting unit in the stylization model to obtain the target stylized image and the key point information, respectively.

12. The electronic device according to claim 11, wherein the one or more processors are caused to process the feature to be processed based on a stylizing unit and a key point extracting unit in the stylization model to obtain the target stylized image and the key point information, respectively by being caused to:
process the feature to be processed based on at least one convolutional layer and an up-sampling layer in the stylizing unit to obtain the target style image with the target object deformed; and
process the feature to be processed sequentially based on a down-sampling layer, a flatten layer, and a linear layer in the key point extracting unit to obtain the key point information after the target object is deformed.

13. The electronic device according to claim 10, wherein the key point information comprises a pixel coordinate of a predefined key point after the target object is deformed; or the key point information comprises a pixel coordinate and a depth coordinate of a predefined key point after the target object is deformed.

14. The electronic device according to claim 10, wherein the target task comprises a task for mounting a two-dimensional special effect object and/or a three-dimensional special effect object for the target object based on the key point information.

15. The electronic device according to claim 10, wherein the one or more processors are further caused to:
obtain a plurality of sample images;
determine a three-dimensional reconstruction model corresponding to a target object in the sample image, and determine mesh point information of at least one predefined key point in the three-dimensional reconstruction model;
deform the three-dimensional reconstruction model based on deformation parameters corresponding to a target style to obtain an actual stylized image, and determine actual key point information corresponding to the mesh point information under the action of the deformation parameters; and
determine a training sample for training the stylization model based on the sample image, the actual stylized image for the sample image, and the actual key point information.

16. The electronic device according to claim 15, wherein the one or more processors are caused to determine actual key point information corresponding to the mesh point information under the action of the deformation parameters by being caused to:
determine coordinate data corresponding to the mesh point information under the action of the deformation parameters; and
based on the coordinate data, a model matrix, a view matrix, and a projection matrix, determine an actual pixel coordinate of the mesh point information in the sample image and using the actual pixel coordinate as the actual key point information.

17. The electronic device according to claim 15, wherein the one or more processors are further caused to:
in response to the target task comprising mounting a three-dimensional special effect object for the target object, determine a depth coordinate of the mesh point information and update the training sample based on the depth coordinate.

18. The electronic device according to claim 15, wherein the one or more processors are further caused to:
train the stylization model based on the training sample,
wherein the one or more processors are caused to train the stylization model based on the training sample by being caused to:
input the sample image in the training sample into the stylization model to perform stylization and key point determination, and output a predicted stylized image and predicted key point information; and
determine a loss value based on the actual stylized image, the actual key point information, the predicted stylized image, and the predicted key point information of the training sample, and correct model parameters in the stylization model based on the loss value until a loss function in the stylization model converges.

19. A non-transitory storage medium comprising computer-executable instructions, wherein the computer-executable instructions, when executed by a computer processor, are used to perform:
obtaining an image to be processed that comprises a target object;
processing the image to be processed based on a pre-trained stylization model to obtain a target style image with the target object stylized as well as key point information of the target object after the stylization; and
processing, based on a preset target task and the key point information, the target style image to obtain a target special effect corresponding to the target task.

20. The non-transitory storage medium according to claim 19, wherein the processing the image to be processed based on a pre-trained stylization model to obtain a target style image with the target object stylized as well as key point information of the target object after the stylization comprises:
determining a feature to be processed of the image to be processed based on an encoder in the stylization model, and processing the feature to be processed based on a stylizing unit and a key point extracting unit in the stylization model to obtain the target stylized image and the key point information, respectively.
